(19) United States
(12) Patent Application Publication
(10) Pub. No.: US 2024/0309892 A1
(43) Pub. Date: Sep. 19, 2024

(54) Pneumatic Drive Apparatus

(71) Applicant: Adaptas Solutions LLC, Palmer, MA (US)

(72) Inventors: Erik Miller, Belchertown, MA (US); David Manura, Belchertown, MA (US); Florent Junod, Anières (CH)

(21) Appl. No.: 18/605,955

(22) Filed: Mar. 15, 2024

Related U.S. Application Data
(60) Provisional application No. 63/490,859, filed on Mar. 17, 2023.

(51) Int. Cl. F15B 1/26; F15B 13/06

(52) U.S. Cl. CPC F15B 1/265; F15B 13/06

(57) ABSTRACT

A pneumatic circuit for a pneumatic drive apparatus is disclosed. The pneumatic circuit includes a reservoir, a pump, and first, second and third valves. The first valve selectively provides a fluid connection between an inlet of the pump and the reservoir. The second valve selectively provides a fluid connection between an outlet of the pump and the reservoir. The third valve selectively provides a fluid connection between the reservoir and an actuation port. The pneumatic circuit is configured such that the first and second valves can selectively pressurise the reservoir, and such that the third valve can selectively communicate pressure from the reservoir to the actuation port.

### CROSS REFERENCE TO RELATED APPLICATIONS

The present application claims priority to U.S. Provisional Patent Application No. 63/490,859 filed Mar. 17, 2023, the entire contents of which are herein incorporated by reference as if fully set forth in this description.

### FIELD OF THE INVENTION

The present disclosure relates to a micro-fluidic pneumatic circuit for a micro-fluidic pneumatic drive apparatus for use in fluid aspiration and dispensing applications, and a manifold for such a micro-fluidic pneumatic drive apparatus.

### BACKGROUND OF THE INVENTION

Micro-fluidic pneumatic circuits are used in a variety of different applications, for controlling systems which dispense and aspirate various kinds of fluid. In the present context, micro-fluidic applications mean those in which maximum required volumetric fluid flows are of the order of 1 to hundreds of microlitres per minute or up to several (i.e. around 3 to 10) hundred microlitres per minute, and pipetting apparatus is used for aspirating or dispensing doses in the range of 1 microlitre to several millilitres.

Solutions exist in which positive and negative pressures and flows can be controlled in a pneumatic circuit, in order to control the aspiration and dispensing of fluids through pipetting heads, to aspirate and dispense fluids.

Depending upon the fluid circuitry used, drawbacks associated with known systems include difficulties in providing accurate and repeatable dispensing pressures and volumes, and the range of components required to implement sufficiently flexible and accurate control systems can result in undesirable levels of cost and complexity.

It is an aim of the present disclosure to provide a pneumatic circuit which addresses drawbacks in the prior art.

### SUMMARY OF THE INVENTION

The inventors have identified a need for a compact system that may be used to control fluid flow in a range of applications including aspirating and dispensing fluid from a pipette, and continuously driving fluid from a fluid source.

According to a first aspect of the present invention, there is provided a pneumatic circuit comprising any or all of the following features: a reservoir; a pump; a first valve operable to selectively provide a fluid connection between an inlet of the pump and the reservoir; a second valve operable to selectively provide a fluid connection between an outlet of the pump and the reservoir; and a third valve configured to selectively provide a fluid connection between the reservoir and an actuation port. The pneumatic circuit is configured such that the first and second valves are operable to selectively pressurise the reservoir, and such that the third valve is operable to selectively communicate pressure from the reservoir to the actuation port. Arranging the first and second valves as such may allow the reservoir to be charged with a positive or negative relative pressure using a pump driving air in a single direction, with no need to reconfigure the pump. The pump may be a pneumatic pump and/or may form a single pressure source for the circuit.

The pneumatic circuit may be a micro-fluidic pneumatic circuit. One or more of the valves in the pneumatic circuit may be micro-fluidic valves. In this respect, the pneumatic circuit may be configured to dispense doses with microlitre precision. The pneumatic circuit may be configured to dispense doses smaller than 1 millilitre, preferably smaller than 100 microliters, preferably smaller than 10 microlitres, preferably smaller than 5 microlitres, preferably smaller than 2 microlitres.

The first valve may have a first position and a second position. The first position may provide a fluid connection between the inlet and an external region, and the second position may provide a fluid connection between the inlet and the reservoir. The second valve may have a first position and a second position. The first position may provide a fluid connection between the outlet and the external region, and the second position may provide a fluid connection between the outlet and the reservoir. Each of the first valve and the second valve may therefore be a three port two position (3/2) valve.

The first valve may be biased towards its first position. The second valve may be biased towards its first position. Biasing at least one of the valves towards its first position may provide a fail-safe in the event of a malfunction. For example, both valves may be biased towards their first positions to ensure that the reservoir is sealed in the event of valve malfunction.

The third valve may have an open position and a closed position. The open position may provide a fluid connection between the reservoir and the actuation port. The closed position may prevent fluid connection between the reservoir and the actuation port. The third valve may be biased towards the closed position. Biasing the third valve towards its closed position may ensure that the reservoir remains sealed in the event of valve malfunction.

The pneumatic circuit may further comprise a pressure sensor configured to sense pressure in the reservoir. This data may be recorded and used to selectively actuate the valves and/or provide a feedback signal to the pump such that the pressure can be maintained via closed loop control.

The pump may be configured to pump gas from the inlet to the outlet. The pump may be a pneumatic pump. A gas such as air may be used as the working fluid within the pneumatic circuit, which is readily available and requires no designated working fluid reservoir.

The pneumatic circuit may be used in series with an additional fluid control system to provide a continuous flow of fluid from a fluid source. This may be achieved by running the pump to continuously drive air from an external region into a fluid source to pressurise the fluid source, or to pull air from an external region (such as a fluid reservoir) to fill the fluid source. Running the pump may be performed in a controlled manner, with closed loop control on the flow rate via an optional flow meter. Providing a pneumatic circuit with three valves that may be selectively actuated may allow a pump driving air from an input to an output to be used in a range of different situations without the need to reconfigure the pump or associated pneumatic circuit. This may therefore require fewer switching operations between components compared to other pneumatic circuits.

According to another aspect of the invention, there is provided a pneumatic drive apparatus. The pneumatic drive apparatus may comprise any, or all features of the pneumatic circuit described hereinabove. In the context of the pneumatic drive apparatus, the pump is optional.

The pneumatic drive apparatus may comprise a valve manifold, which may also be termed a valve block. The manifold may comprise a main body in which the reservoir is comprised.

The main body may be configured to support a least one of the first valve, the second valve and the third valve. Providing a main body which may comprise the reservoir and the first, second and third valves may allow a compact pneumatic drive apparatus to be provided.

The valve block may define an internal volume of less than 25 millilitre (ml).

The manifold may comprise any combination of a first recess, a second recess and a third recess to receive the first, second and third valves respectively. Each valve may be at least partially contained in its respective recess.

The first recess and/or the second recess and/or the third recess may each have a longitudinal axis. The longitudinal axes of any combination of the first recess, the second recess and the third recess may be parallel to one another or more generally extend in a common longitudinal direction of the manifold.

Any of the first valve, the second valve and the third valve may be cylindrical. Any of the first recess, the second recess and the third recess may be cylindrical. Cylindrical may refer to a shape that is generally cylindrical and may have any further combination of keyways and extrusions.

The first recess and/or the second recess and/or third recess may each have an abutment. An abutment may be a surface perpendicular to the longitudinal axis of a recesses. An abutment may be circular or annular in shape. An abutment may contact a valve to retain the valve axially within a recess.

The abutments of any combination of the first recess, the second recess and the third recess may be coplanar. The abutment of the third recess may be parallel to the abutment of the first recess and/or second recess and offset in a direction parallel to a longitudinal axis of the first recess and/or second recess.

The first recess, second recess and third recess may each have a depth of less than 20 mm, wherein depth is the distance between the surface from which a recess extends and the abutment of a recess. The depth of any of the first recess, second recess and third recess may be equal.

The valve block may comprise a bore for receiving the actuation port. The actuation port bore may have a longitudinal axis arranged colinear with the longitudinal axis of the third recess. The actuation port bore may be adjacent to the abutment of the third valve recess.

The main body may be formed of a unitary body. A unitary body may be defined as a body manufactured from a single piece of material. The main body may be made from a single piece of plastic, metal or alloy or any solid material. Manufacturing the main body from a single piece of material may improve ease of manufacture and/or may reduce the likelihood of poor seals between any different pneumatic drive apparatus components.

The reservoir may comprise a first chamber adjacent the first valve. The reservoir may comprise a second chamber adjacent the second valve. The first and second chambers may be arranged in a common plane with the actuation port. The first and second chambers may be arranged on opposite sides of the actuation port. The first and second chambers may be connected by a connecting channel. This arrangement may improve compactness and ease of manufacture of the main body.

The first chamber may be defined by a cylindrical bore within the main body. The second chamber may be defined by a cylindrical bore within the main body. This may allow the first chamber and/or second chamber to be manufactured by a drilling or boring operation, or by any suitable material removal process.

The first chamber and the second chamber may each have a longitudinal axis. The longitudinal axes of the first chamber and the second chamber may be parallel to one another. This arrangement may allow for a compact arrangement of the reservoir.

The longitudinal axis of the first chamber may be colinear with the longitudinal axis of the first recess. The longitudinal axis of the second chamber may be colinear with the longitudinal axis of the second recess. Any of the valves may be arranged to plug an opening of its respective recess, and therefore may plug or provide a closure to seal an associated reservoir.

The connecting channel may extend between the first and second chambers in a transverse direction with respect to the longitudinal axes of the first and/or second chamber.

At least part of the third valve may be provided in the reservoir connecting channel. This arrangement may allow the third valve to be fluidly connected to the reservoir via the connecting channel.

An attachment port for a pressure sensor may be provided in the manifold. The attachment port may be provided in communication with one or more of the reservoirs in the manifold Connection between the pressure senor and reservoir or reservoirs may be provided by a sensor connecting channel. The sensor connecting channel may be in fluid communication with the reservoir connecting channel. The reservoir connecting channel may have a longitudinal axis. The pressure sensor may be received in a transverse opening in the main body colinear with the longitudinal axis of the connecting channel. This arrangement may allow for ease of manufacture of the pneumatic drive apparatus as a single bore may form both the reservoir connecting channel and the pressure sensor receiving opening and or sensor connecting channel.

Any combination of the first valve, the second valve and the third valve may be configured to actuate a corresponding valve plunger in an actuation direction. The actuation directions of any combination of the first valve, the second valve and the third valve may be parallel.

According to another aspect, there is provided pneumatic drive unit comprising any or all of the following features:
a housing; and
a pneumatic drive apparatus having features as described herein, disposed within the housing;
the housing having a width direction transverse to a longitudinal axis of the actuation port, and comprising:
   a first portion having a first width in the width direction and containing the pump; and
   a second portion having a second width in the width direction and containing the valve manifold;
   wherein the first width is greater than the second width.

According to another aspect of the present invention, there is provided an assembly comprising a plurality of pneumatic drive units. At least one of the plurality of units may comprise a pneumatic drive apparatus having any or all features as described hereinabove.

The plurality of units may be arranged such that the actuation ports of the plurality of units form a linear array.

Each of the plurality of units may comprise a pump. The pumps of the plurality of units may be comprised on lateral sides of the linear array. The pumps of the plurality of units may be distributed along opposing lateral sides of the linear array

Each unit may comprise a housing. The housing may comprise a first portion having a first width in the width direction and containing the pump, and a second portion having a second width in the width direction and containing the valve block. The first width may be greater than the second width. The width of each section of housing may be measured parallel to the linear arrangement of actuation ports.

The housing may comprise a pump, a controller and a pipette holder, which may be a pipette mandrel. The pipette holder may be fluidly connected to the actuation port.

The housing may have a prismatic shape with a constant cross section extending along an axis to define the housing height. The cross section may have a “T” shape to define a first section and a second section of the housing. The first section may have a greater width than the second section. The width of each section may be measured normal to a height axis of the housing. The height axis of the housing may be in the direction of a longitudinal axis of the actuation port, or in a direction of a longitudinal axis of one or more of a valve, a valve receiving recess, or a reservoir or other channel of the manifold.

The pipette holder may comprise a hollow tube having an outer diameter equal to the inner diameter of a pipette such that the pipette holder may be inserted into a pipette. Alternatively, the pipette holder may comprise a hollow tube having an inner diameter equal to the outer diameter of a pipette such that a pipette is insertable into the pipette holder.

The pipette holder may comprise a sealing element arranged to form a fluid seal with a pipette. This may prevent the loss of working fluid between the actuation port and the pipette which may allow closer control over the volume of fluid aspirated or dispensed.

The distance between the centre points of adjacent pipette holders may be 8 mm. The distance between the centre points of adjacent pipette holders may be 9 mm. This may align with the wells in an industry standard sample tray, such as a 96-well micro-titer plate, such that the assembly may be used to aspirate and/or dispense multiple samples at the same time from or into a sample tray.

The housings of adjacent units within the assembly may abut one another.

Adjacent units within the assembly may be rotated by 180 degrees about the height axis of their housing relative to their adjacent units. The assembly may therefore comprise a series of units in alternating orientations. The second sections of each housing may therefore abut the second sections of the housings adjacent to it. This arrangement may provide a more compact arrangement of units.

### BRIEF DESCRIPTION OF THE DRAWINGS

Further features and advantages of the present invention will become apparent from the following description of embodiments thereof, presented by way of example only, and by reference to the drawings, in which:

FIG. 1 is a circuit diagram of a pneumatic circuit according to an embodiment;

FIG. 2 is a circuit diagram of the pneumatic circuit of FIG. 1 incorporated into an air-over-liquid device;

FIG. 3 is a cross sectional view illustrating a valve block according to an embodiment;

FIG. 4 is a schematic diagram illustrating the main body of the valve block according to an embodiment;

FIG. 5 is a schematic cross sectional view of the main body of FIG. 4;

FIG. 6 is a schematic view of a pneumatic drive apparatus according to an embodiment;

FIG. 7 is a schematic view of a unit incorporating a pneumatic drive apparatus according to an embodiment;

FIG. 8 is an assembly having a plurality of units according to FIG. 7.

### DETAILED DESCRIPTION

In a first aspect, the disclosure relates to a pneumatic circuit, which may be incorporated into a pneumatic drive apparatus to deliver positively- or negatively-pressured gas to an actuation port, which may be connected to a pipette such that liquid can be aspirated or dispensed via apparatus connected to the actuation port. The arrangement makes use of three valves and a pump to selectively apply positive or negative pressure to a reservoir, which in turn can be connected to the actuation port for aspirating or dispensing fluid through a pipette. Two of the valves can be fluidly connected to a pump and can be actuated to connect the pump to either the reservoir or to ambient air. By controlling the valves, a pump driving air in a single direction through the pump can be used to draw air out of or force air into the reservoir, generating a negative or positive pressure, respectively. The third valve can be used to control a fluid connection between the reservoir and the actuation port. As will be appreciated, beneficial arrangements based upon the following disclosure using a single pump as described or using other source of negative or positive pressure.

The volume of fluid aspirated or dispensed can be controlled by monitoring the pressure within the reservoir using a pressure sensor. Once the reservoir has been pressurised, the third valve may be opened and closed sequentially to move a defined volume of gas through the actuation port, to enable a defined volume of fluid, which may be another fluid such as a liquid, to be collected or dispensed using a connected pipette head.

The valves and reservoir are housed within bores in a valve block. The inventors have designed the valve block such that the required bores can be conveniently manufactured using standard material removal processes, for example, boring or drilling operations. The valves can be arranged in a manifold in substantially the same plane, in order to provide a low-profile device. In this way, multiple units of the device can be stacked together to provide an assembly capable of aspirating liquid into, or dispensing liquid from, multiple pipettes.

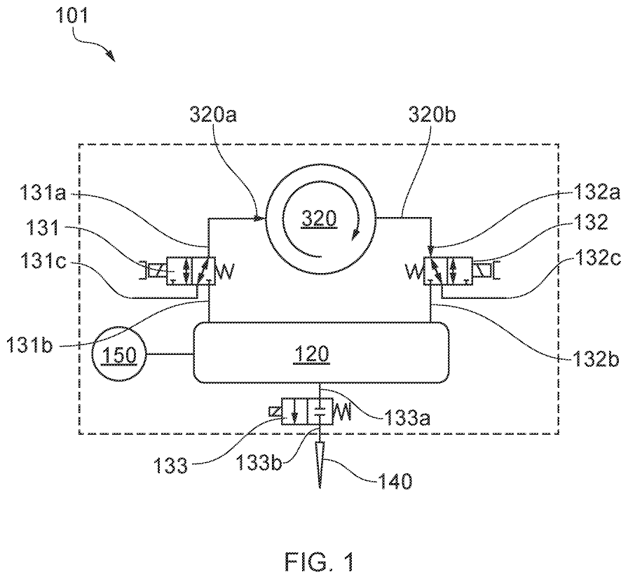

FIG. 1 illustrates a pneumatic circuit 101. The pneumatic circuit 101 comprises a first valve 131, a second valve 132, a third valve 133, a pump 320, a reservoir 120 and an actuation port 140. The pneumatic circuit 101 may also comprise a pressure sensor 150 arranged to sense the pressure within the reservoir 120. The pump 320 can be configured to pump a working fluid, which may be a gas, such as air, from an inlet 320a to an outlet 320b.

The first valve 131 is operable to selectively provide a fluid connection between the inlet 320a and the reservoir 120. The second valve 132 is operable to selectively provide a fluid connection between the outlet 320b and the reservoir 120. The third valve 133 is configured to selectively permit flow between the reservoir 120 and the actuation port 140. In the arrangement shown, the first valve 131 has a first position and a second position. The first position permits flow between the inlet 320a and a region external to the pneumatic circuit, which may be ambient air, or another air reservoir, which may be maintained at a constant pressure. The second position permits flow between the inlet 320a and the reservoir 120. The second valve 132 also has a first position and a second position. The first position permits flow between the outlet 320b and the external region, while the second position permits flow between the outlet 320b and the reservoir 120.

The first valve 131 and/or the second valve 132 may be a three-port two-position (3/2) valve. In the illustrated example, the first valve 131 comprises a first fluid port 131a, a second fluid port 131b and a third fluid port 131c. The first valve 131 may also comprise a plunger 131d. The plunger 131d may be moveable in the first valve 131 to connect or disconnect fluidic flowpaths through the first valve 131, such as flow paths between first fluid port 131a, second fluid port 131b and third fluid port 131c. The movement of the plunger 131d may be in a longitudinal direction of the axis A1. The plunger 131d may be configured to move in the first valve 131 between a first seat 131e and a second seat 131f. The first fluid port 131a is configured to be fluidly connected to the inlet 320a. The second fluid port 131b is configured to be fluidly connected to the reservoir 120. The third fluid port 131c is configured to be fluidly connected to the external region. In the first position of the first valve 131, the first fluid port 131a is fluidly connected to the third fluid port 131c and the plunger 131d is seated in the first seat 131e fluidly disconnecting the second fluid port 131b from the first fluid port 131a. In the second position, the first fluid port 131a is fluidly connected to the second fluid port 131b and the plunger 131d is seated in the second seat 131f fluidly disconnecting the third fluid port 131c from the first fluid port 131a. The first valve 131 may be biased towards either position, for example the plunger 131d may be biased to be seated in the first seat 131e or the second seat 131f. The biasing may be a spring bias. In the arrangement shown, the first valve 131 is biased towards the first position. The first valve 131 may be a solenoid valve, in such a case, the plunger 131d may be actuated by exciting the coil of the solenoid valve.

Similarly, the second valve 132 comprises a first fluid port 132a, a second fluid port 132b and a third fluid port 132c. The second valve 132 may also comprise a plunger 132d. The plunger 132d may be moveable in the valve 132 to connect or disconnect fluidic flowpaths through the second valve 132, such as flow paths between first fluid port 132a, second fluid port 132b and third fluid port 132c. The movement of the plunger 132d may be in a longitudinal direction of the axis A2. The plunger 132d may be configured to move in the second valve 132 between a first seat 132e and a second seat 132f. The first fluid port 132a is configured to be fluidly connected to the outlet 320b. The second fluid port 132b is configured to be fluidly connected to the reservoir 120. The third fluid port 132c is configured to be fluidly connected to the external region. In the first position of the second valve 132, the first fluid port 132a is fluidly connected to the third fluid port 132c and the plunger 132d is seated in the first seat 132e fluidly disconnecting the second fluid port 132b from the first fluid port 132a. In the second position, the first fluid port 132a is fluidly connected to the second fluid port 132b and the plunger 132d is seated in the second seat 132f fluidly disconnecting the third fluid port 132c from the first fluid port 132a. The second valve 132 may be biased towards either position, for example the plunger 132d may be biased to be seated in the first sear 132e or the second seat 132f. The biasing may be a spring bias. In the arrangement shown, the second valve 132 is biased towards the first position. The second valve 132 may be a solenoid valve, in such a case, the plunger 132d may be actuated by exciting the coil of the solenoid valve.

The third valve 133 comprises a first fluid port 133a and second fluid port 133b. The third valve 133 may also comprise a plunger 133d. The plunger 133d may be moveable in the valve 133 to connect or disconnect fluidic flowpaths through the third valve 133, such as flow paths between first fluid port 133a, second fluid port 133b and actuation port 140. The movement of the plunger 133d may be in a longitudinal direction of an axis A7. The plunger 133d may be configured to move in the valve 133 into and out of a seat 133e. The first fluid port 133a is configured to be fluidly connected to the reservoir 120, and the second fluid port 133b is configured to be fluidly connected to the actuation port 140. The third valve 133 has an open position and a closed position so as to selectively permit flow between the first fluid port 133a and the second fluid port 133b. In the closed position, the plunger 133d is seated in seat 133e to prevent fluid communication between the first fluid port 133a and the second fluid port 133b. The plunger 133d may be biased towards either the open or closed position. The biasing may be a spring bias. In the arrangement shown, the third valve 133 is biased towards the closed position. The valve 133 may be a solenoid valve, in such a case, the plunger 133d may be actuated by exciting the coil of the solenoid valve.

In operation, a positive or negative pressure drive may be provided at the actuation port 140 by selectively actuating the first valve 131, second valve 132 and third valve 133, and using the pump 320 to drive fluid around the pneumatic circuit 101. For example, with the pump running continuously in a single direction and by configuring the first valve 131 in its second position (to connect the reservoir 120 to the pump inlet 320a), the second valve 132 in its first position (to connect the pump outlet 320b to the external region) and the third valve 133 in its closed position, the pump 320 may be used to draw air from the reservoir 120, through the first valve 131, through the pump 320 and out to the external region via the second valve 132. Forcing fluid out of the reservoir 120 reduces the pressure within the reservoir 120, which may be monitored by the pressure sensor 150. This can be performed for a predetermined time and/or until a threshold pressure is measured by the pressure sensor 150. In this respect, the pneumatic circuit 101 may include a controller (not shown) configured to control the actuation of the valves 131, 132, 133. Once the required pressure is achieved, the first valve 131 may be configured to be in its first position, thereby sealing the pressurised reservoir 120 from the external region. Notably, the pump 320 need not be switched off, but rather may continue to operate without affecting the pressure in the reservoir 120.

After charging the reservoir 120 with a negative pressure in this way, the third valve 133 may then be opened to permit flow between the reservoir 120 and the actuation port 140. In this case, the reduced relative pressure in the reservoir 120 will draw fluid through the actuation port 140, and hence may be used to aspirate a pipette tip connected thereto.

Similarly, the reservoir 120 may be positively pressurised by forcing fluid into the reservoir 120 by configuring the first valve 131 in its first position, the second valve 132 in its second position and the third valve 133 in its closed position, while continuously operating the pump 320. This will draw air from the external region, through the first valve 131, through the pump 320 and into the reservoir 120 via the second valve 132. Again, once the reservoir 120 has been pressurised to the required pressure, the third valve 133 may be opened and in this case the increased pressure of the reservoir 120 relative to the external region will expel fluid from the actuation port 140, and hence may be used to dispense fluid from an aspirated pipette connected to the actuation port 140.

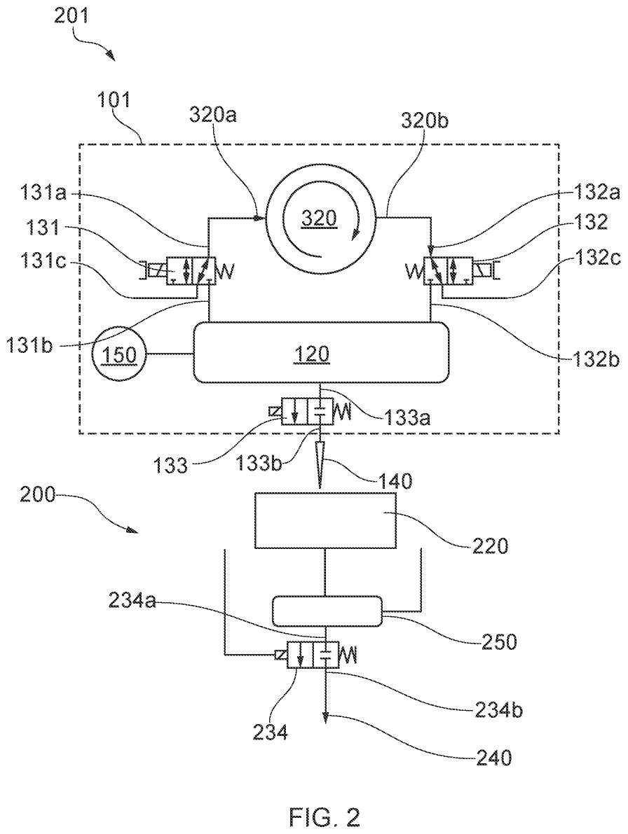

FIG. 2 shows a circuit diagram of a liquid flow controller 201 incorporating the pneumatic circuit 101. As explained above, the pneumatic circuit 101 can provide a positive or negative pressure drive at the actuation port 140. The illustrated arrangement can use the pneumatic circuit 101 in series with an additional fluid control system 200 to provide a continuous flow of fluid, which may be liquid, from a fluid source 220 through a conduit 240. A flow sensor 250 and a fourth valve 234 may be provided to measure and control the liquid flow, wherein the fourth valve 234 is configured to selectively permit flow between the flow sensor 250 and the conduit 240.

In the illustrated example, a fourth valve 234 is included downstream of the fluid source 220 to selectively permit flow between the fluid source 220 and the conduit 240. The fourth valve 234 may comprise a first fluid port 234a and a second fluid port 234b. The first fluid port 234a is configured to be fluidly connected to the fluid source 220, optionally via the flow sensor 250, and the second fluid port 234b is configured to be fluidly connected to the conduit 240. The fourth valve 234 has an open and closed position so as to selectively permit flow between the first fluid port 234a and second fluid port 234b and may be biased towards either position. In the arrangement shown, the fourth valve 234 is biased towards the closed position. The fourth valve 234 and the flow sensor 250 may be configured to be controlled by and to communicate with the controller.

In the arrangement shown, the actuation port 140 is fluidly connected to the fluid source 220 containing a liquid to be dispensed or metered. The pneumatic circuit 101 can be configured to deliver a continuous drive of positive pressure to the actuation port 140. With the pump 320 running continuously, this can be achieved by configuring the first valve 131 to be in its first position such that air is drawn into the first fluid port 131a via the third fluid port 131c, configuring the second valve 132 to be in its second position such that air is pumped from the first fluid port 132a to the second fluid port 132b, and opening the third valve 133 so that air from the pump flows out of the actuation port 140.

In operation, as air is driven into the fluid source 220 via the actuation port 140, the increase in pressure drives liquid from the fluid source 220 toward the conduit 240. When the fourth valve 234 is opened, the liquid can flow into the conduit 240. The flow sensor 250 can measure the rate of flow and provide this information to the controller. Using a fourth valve to selectively permit fluid flow allows the liquid flow controller 201 to instantaneously stop or begin fluid flow through the conduit 240, instantaneous here being defined as the time taken to actuate the fourth valve 234 between its open and closed positions. Without this fourth valve 234, the flow of the liquid may only be controlled by actuating the pump 320 and/or valves of the pneumatic circuit 101. In the case of ceasing pressure drive from the actuation port 140, this may allow some additional volume of liquid to be dispensed from the conduit 240 at a gradually reducing flow rate. In comparison, the fourth valve 234 allows much closer control over stopping the flow of fluid through the conduit 240 which may be beneficial in applications where precise volumes of liquid must be dispensed.

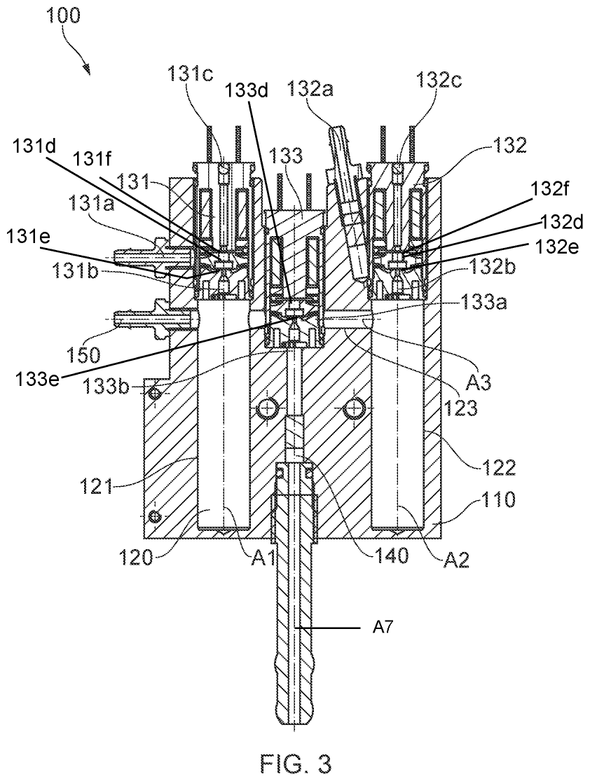

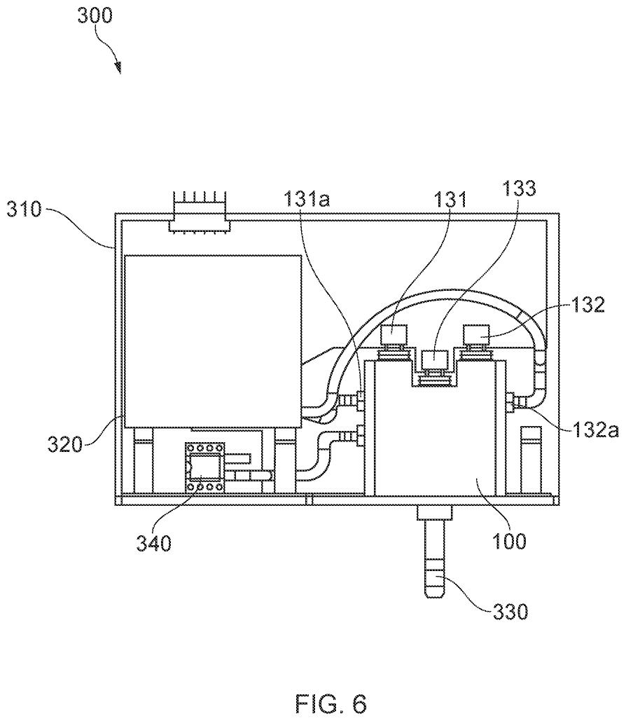

FIG. 3 illustrates a cross section view of a valve block 100 which can form a manifold for receiving various components to be fluidly connected to form the fluid circuits previously described. The valve block 100 may be comprised in a pneumatic drive apparatus 300 (see FIG. 6) and may at least partly incorporate the features of the pneumatic circuit 101. The valve block 100 may comprise a main body 110 in which further components and features are housed or fastened. The main body 110 may be configured to support the first valve 131, second valve 132 and third valve 133, and may contain the reservoir 120 and the actuation port 140. The main body 110 may be formed of a unitary body.

The reservoir 120 may comprise a first chamber 121 and a second chamber 122, wherein the chambers are connected by a connecting channel 123. Each of the chambers 121, 122, and/or the connecting channel 123 may be defined by a cavity within the main body 110, and may be manufactured by material removal processes such as drilling, casting or moulding processes or any other method including additive manufacture. The first chamber 121 and second chamber 122 may each have a longitudinal axis, A1 and A2 respectively. The first longitudinal axis A1 and the second longitudinal axis A2 may be aligned parallel to one another. The connecting channel 123 may have a longitudinal axis A3 and may extend between the first chamber 121 and the second chamber 122 such that its longitudinal axis A3 is perpendicular to the longitudinal axes A1 and A2 of the first chamber 121 and the second chamber 122.

The third valve 133 may be configured to selectively permit flow between the connecting channel 123 and the actuation port 140. This may be achieved by arranging the third valve 133 such that the connecting channel 123 passes through the valve via a shared port, as shown in FIG. 3.

The pressure sensor 150 may be arranged to be in fluid communication with the reservoir 120 and may be at least partly received in a transverse opening in the main body 110, which may be colinear with the connecting channel longitudinal axis A3. Arranging the pressure sensor 150 as such means that a single hole can be manufactured by drilling or otherwise to form the connecting channel 123, and this hole may then also serve as the transverse opening into which at least a part of the pressure sensor 150, such as an input thereof, is received. This may improve ease of manufacture as it may minimise the number of operations required to manufacture the main body 110.

The first valve 131 may comprise the first fluid port 131a provided in a bore in the main body 110, which may be normal to a longitudinal axis of the first valve 131. The bore may extend away from the second valve 132 and/or the third valve 133. The bore may be arranged to be formed in the block from a same side as other recesses, cavities or channels, such as the connecting channel 123, which may improve ease of manufacture of the main body 110.

The second valve 132 may comprise the first fluid port 132a provided in a second bore extending between the second valve 132 and the third valve 133. The second bore may extend at a non-zero or at an acute angle relative to a longitudinal axis of the second valve 132. The second bore may extend at an angle of between 5 and 15 degrees to the longitudinal axis of the second valve 132. Arranging the first fluid port 132a of the second valve 132 in this manner may provide a more compact valve block 100 with more efficient packaging of components and a reduced profile. The main body 110 may comprise a surface arranged perpendicular to the second bore. This may improve ease of manufacture of the second bore and/or ease of assembly of the first fluid port 132a of the second valve 132.

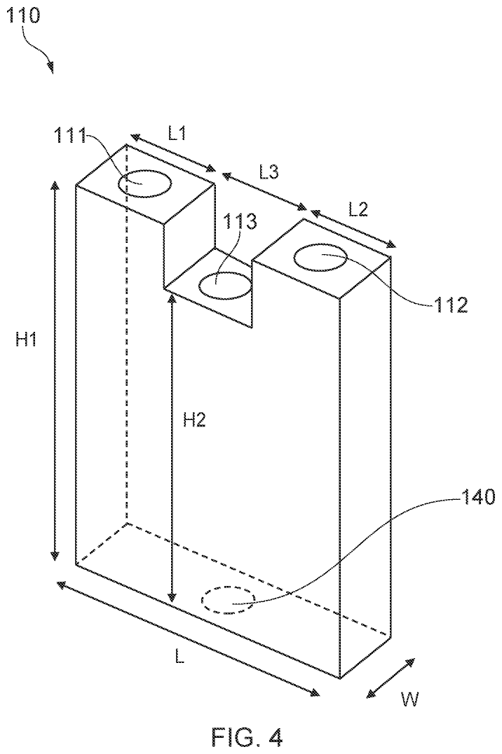

FIG. 4 shows a schematic representation of the main body 110 with valves removed, having an overall width W, height H1 and length L. The main body 110 comprises a first recess 111, a second recess 112 and a third recess 113 to receive the first valve 131, the second valve 132 and the third valve 133 respectively. Each valve may be retained in its corresponding recess by an interference fit or a threaded engagement. The main body 110 may be generally cuboidal and may have a stepped profile as shown in FIG. 4. The stepped profile may have a cut-out having a height H2 between two stepped portions, wherein H2 is less than H1. The cut out may have a length L3 and may be arranged such that the lengths of the stepped portions L1 and L2 are equal. The lengths of the stepped portions L1, L2 and the length of the cut out L3 may all be equal. The main body 110 may be a unitary body, for example formed from a single piece of material using material removal processes, moulding, additive manufacture, or other processes described herein.

Each of the first recess 111, second recess 112 and third recess 113 may be cylindrical. The diameter of any of the first recess 111, second recess 112 and third recess 113 may be at least three quarters or at least nine tenths of the width W of the main body 110. Providing the recesses as such may improve the packaging efficiency of the main body 110 which may reduce the overall size of the valve block 100. Overall the size of the recesses may dictate the size of the main body 110, and as such providing the main body 110 with width W only slightly larger than the circumference of the recesses may allow a more compact valve block 100 to be provided.

The main body 110 may further comprise any combination of external channels or extrusions not shown which may give rise to local variations in the width W of the main body 110. These may act over the full height H1 of the main body 110 or over a portion of the height H1 only. Channels may be used to reduce the width W of the main body 110 and reduce the amount of material required to manufacture the main body 110. Extrusions may be used to increase the width W of the main body 110 to increase the strength of the main body 110, for example in regions of high stress during manufacture.

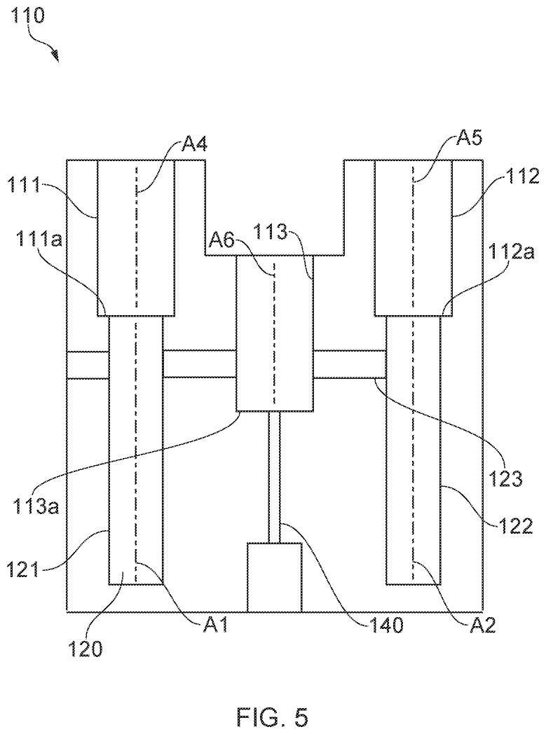

FIG. 5 shows a cross section through the main body 110. The first recess 111 and the second recess 112 may have a longitudinal axis A4 and A5 respectively. The first recess longitudinal axis A4 and the second recess longitudinal axis A5 may be parallel to one another. The third recess 113 may also have a longitudinal axis A6 parallel to the first recess longitudinal axis A4 and/or to the second recess longitudinal axis A5.

Each of the first recess 111, the second recess 112 and the third recess 113 and their associated first valve 131, second valve 132 and third valve 133 may be cylindrical. Each recess can be shaped to house a valve and as such the exact shape of the recess may be dependent on the exact shape of the valve. A skilled person will appreciate that a cylindrical recess and/or valve may be generally cylindrical and further comprise any combination of keyways, extrusions or any other feature common to valves.

Each of the first recess 111, the second recess 112 and the third recess 113 may comprise an abutment numbered 111a, 112a and 113a respectively within the main body 110. Each abutment is annular in shape and may be a ledge arranged to contact and support a valve. This arrangement may prevent each valve from being inserted too far into the main body 110. Each abutment may be provided by a chamber extending adjacent to a recess, the recess having a larger diameter than the chamber. The thickness of an abutment may therefore be defined as half the difference in diameter of a recess and a chamber that extends adjacent to that recess. The first abutment 111a and the second abutment 112a may have an equal thickness, and this thickness may be at least 0.4 millimetre (mm). The third abutment 113a may have a greater thickness than the first abutment 111a and/or the second abutment 112a, and this thickness may be at least 2.8 mm.

Each abutment is perpendicular to the longitudinal axis of that recess and defines the depth of the recess, measured from the surface from which the recess extends. The first recess 111 and the second recess 112 may be arranged such that the first abutment 111a and second abutment 112a are parallel or coplanar. The first recess 111 and second recess 112 may also have the same depth, defined as the distance between the recess abutment and the surface from which that recess extends.

An overall depth of end surface may be defined as the distance between the abutment of a recess and the surface from which the first recess 111 and/or second recess 112 extends. Accordingly, the third recess 113 may be arranged such that the third abutment 113a is at a lower overall depth than the first abutment 111a and/or second abutment 112a. The first recess 111, second recess 112 and third recess 113 may all have the same depth, and this depth may be specified to be less than 18 mm.

The third recess 113 may be arranged such that the third abutment 113a is parallel to the first abutment 111a and/or the second abutment 112a and is offset from the first abutment 111a and/or the second abutment 112a in a direction parallel to the longitudinal axis of the third recess A6. The third abutment 113a may be offset in a direction parallel to the longitudinal axis A6 of the third recess 113 and away from the surface from which the first recess 111 and/or second recess 112 extend.

The longitudinal axis of the first chamber A1 may be colinear with the longitudinal axis of the first recess A4, and the first chamber 121 may extend from the first abutment 111a. Arranging the first chamber 121 and first recess 111 as such improves ease of manufacture, and the interface between the two may be used as the connecting port between the first valve 131 and the reservoir 120.

The longitudinal axis of the second chamber A2 may be colinear with the longitudinal axis of the second recess A5, and the second chamber 122 may extend from the second abutment 112a. Arranging the second chamber 122 and second recess 112 as such improves ease of manufacture, and the interface between the two may be used as the connecting port between the second valve 132 and the reservoir 120.

The first chamber 121 and second chamber 122 may each define an equal volume, and the volume of each chamber may be less than 2 ml, preferably less than 1.5 ml. The volume of each chamber may be in the order of 1 ml, or between around 0.5 ml and 1.5 ml. Depending on the application, the volume may be as small as the connecting channel 123, and may be as large as several millilitres.

In the illustrated example, the connecting channel 123 extends from the outer surface of the main body 110. Arranging the connecting channel 123 as such improves ease of manufacturability and provides a transverse opening into which the pressure sensor 150 may be inserted.

The overall width W, height H1 and length L of the main body 110 may define a cuboid having a volume of less than 19 ml.

FIG. 6 shows a pneumatic drive apparatus 300. In the arrangement shown, the pneumatic drive apparatus 300 comprises a housing 310, the housing comprising the valve block 100, the pump 320, a pipette holder 330 fluidly connected to the actuation port 140 of the valve block 100, and a controller 340. However, it will be appreciated that the pump 320 need not be part of the pneumatic drive apparatus 300.

It is noted that the first fluid port 132a of the second valve 132 is here arranged normal to a longitudinal axis of the second valve 132 and extending away from the first valve 131 and the third valve 133. It will be appreciated that the first fluid port 132a may be arranged in the position shown in FIG. 6 or that shown in FIG. 3, at an acute angle to the longitudinal axis of the second valve 132 and between the second valve 132 and the third valve 133.

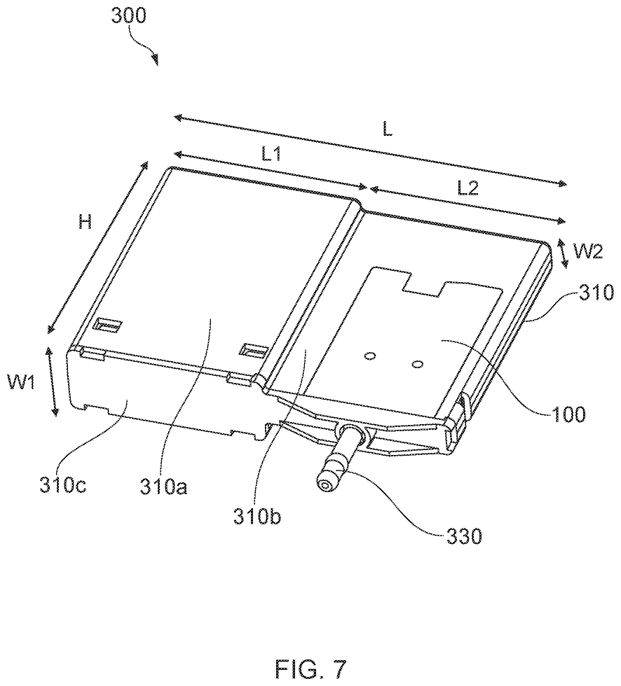

The housing 310 may be sized to efficiently package the valve block 100, the pump 320 and the controller 340 within the housing 310. The maximum height H1 of the valve block 100 as shown in FIG. 4 may be at least one third, preferably at least half of the height H of the housing 310. The valve block 100, pump 320 and controller 340 may be provided in a generally planar arrangement so as to minimise the width W1 and W2 of the housing according to FIG. 7.

The controller 340 can be configured to selectively actuate the pump 320 and/or any of the valves within the valve block 100. In the illustrated example the controller 340 comprises a printed circuit board (PCB) that may further be communicatively coupled to the pressure sensor 150 housed in the valve block 100. Data from the pressure sensor 150 may be input into the controller 340 and used to control selective actuation of the pump 320 and/or any valves within the valve block 100.

The pipette holder 330 may be formed as an integral part of the housing 310 or may be formed as a separate component to the housing 310 subsequently fastened by any suitable means, such as adhesive, clips or screws. The pipette holder 330 may be a hollow tube having an outer diameter equal to the inner diameter of a pipette, such that the pipette holder 330 may be inserted into the pipette. The outer diameter of the pipette holder 330 may take any suitable value dependent on the pipette to be used. The pipette holder 330 may further include a sealing element such as a rubber O-ring on its external surface to form a better seal with a pipette. This may improve control of the fluid aspirated or dispensed through the pipette.

FIG. 7 is a schematic illustration of housing 310. The housing 310 may comprise a first section 310a and a second section 310b. The first section 310a and the second section 310b may be integral to one another, or may be separate components fixed together by any suitable fixing means. The housing 310 may also comprise a top section and/or bottom section, which may form one or more walls of the housing 310. An outer surface of the first section 310a or the second section 310b may comprise a space configured to receive the valve block 100.

In the arrangement shown, the sections 310a, 310b have a substantially cuboidal envelope and are formed together from a single component. The valve block 100 defines at least one wall of the second section 310b. A base section 310c forms a bottom wall of the housing 310. In this way, the housing 310 is configured to form an enclosure around the pneumatic drive apparatus 300 as shown in FIG. 7. This allows components of the pneumatic drive apparatus 300, such as the valve block 100, and the pump 320, to be assembled into the housing 310 through a bottom opening which can be closed by fixing the base section 310c to the first section 310a and/or the second section 310b.

It will be understood by the skilled person that a cuboidal section may not define a perfect cuboid, and as such for example may have chamfered and/or rounded edges. Each section may have the same height H, but may have a different width W and/or length L. The housing 310 may therefore have a first section 310a having a first width W1 and a second section 310b having a second width W2, wherein the first width W1 is greater than the second width W2. The change in width may be a step change as illustrated in FIG. 7, or a gradual change occurring over a length of the housing 310. By providing a housing 310 with a varying width, the housing 310 may be more efficiently packaged. The pump 320 may be wider than the valve block 100, the width of each component measured parallel to the width W of the housing 310 or normal to the plane in which the first valve 131, second valve 132 and third valve 133 lie. The first section 310a may therefore be configured to receive the pump 320 and/or the controller 340 and/or the pressure sensor 150, while the second section 310b may be configured to receive the valve block 100.

The hollow housing 310 may have a generally prismatic shape, with a constant cross section along a single axis. The prism may have a general “T” shaped cross section, extended along an axis normal to the constant cross section to define the height H of the housing 310. The resulting prism may have two planes of symmetry, one parallel to the height H of the housing 310 and one normal to it.

The housing 310 may therefore comprise a first section 310a having a width W1 and a second section 310b having a width W2, wherein W1 is greater than W2. The width of each section can be measured normal to the height H of the housing 310 and normal to the plane of symmetry that is parallel to the height H. The overall length L of the housing may be measured normal to both the height H and width W dimensions and is the sum of the wider section length L1 and the less wide section length L2. The second section 310b may have a length L2 that is greater than the length L1 of the first section 310a.

The pipette holder 330 may have a longitudinal axis coincident with the midpoint of the width W2 of the second section 310b.

Varying the width of the housing 310 along its length L may allow more efficient packaging of the internal components. In the illustrated example, the pump 320 is arranged inside the first section 310a and the valve block 100 is arranged inside the second section 310b. The controller may be a PCB sized to fit the in either or both of the first section 310a and second section 310b.

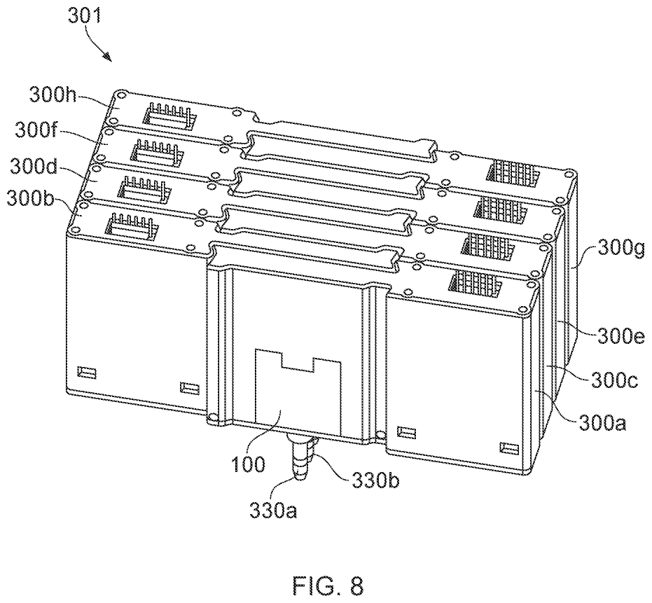

FIG. 8 shows an assembly 301 comprising a plurality of pneumatic drive units, wherein each pneumatic drive unit comprises a pneumatic drive apparatus 300. In the arrangement shown, the assembly comprises eight units 300a-300h. The units may be arranged such that the actuation ports 140 and/or the pipette holders 330 form a linear array along a width direction with respect to the valve blocks 100. The pneumatic drive units 300a-300h can be arranged such that the housing 310 of each unit of the pneumatic drive units 300a-300h abuts the housing of an adjacent unit. For example, a first unit 300a abuts a second unit 300b, which abuts a third unit 300c, and so on.

As illustrated, each unit may be configured in one of two positions. The first position is illustrated by first, third, fifth and seventh units 300a, 300c, 300e and 300g. The second position is illustrated by second, fourth, sixth and eighth units 300b, 300d, 300f and 300h.

All pneumatic drive units 300a-300h can be identical, and the second position differs from the first only in that each unit of the pneumatic drive units 300a-300h is rotated by 180 degrees relative to an adjacent unit about its height axis H defined previously. Positioning adjacent pneumatic drive units 300a-300h in alternating first and second arrangements as shown allows a nested assembly to be created, with the second sections 310b of each apparatus housing 310 abutting the second sections 310b of adjacent apparatus housings 310. Arranging the pneumatic drive units 300a-300h as such may allow for more efficient packing of the unit.

The assembly may further be arranged such that the distance between the centre points of adjacent pipette holders is 8 mm, or 9 mm, or another value between 5 and 15 mm, which spacing may be specified to correspond with a sample tray having wells spaced at corresponding intervals. This may allow multiple samples to be aspirated and/or dispensed by the unit from a single tray at the same time.

Various modifications, whether by way of addition, deletion and/or substitution, may be made to all of the above-described embodiments to provide further embodiments, any and/or all of which are intended to be encompassed by the appended claims.

1. A pneumatic circuit for a pneumatic drive apparatus, comprising:
a pump;
a reservoir;
a first valve operable to selectively provide a fluid connection between an inlet of the pump and the reservoir;
a second valve operable to selectively provide a fluid connection between an outlet of the pump and the reservoir; and
a third valve configured to selectively provide a fluid connection between the reservoir and an actuation port,
the pneumatic circuit being configured such that the first and second valves are operable to selectively pressurise the reservoir, and such that the third valve is operable to selectively communicate pressure from the reservoir to the actuation port.

2. The pneumatic circuit of claim 1, wherein the first valve has a first position and a second position, the first position providing a fluid connection between the inlet and an external region, and the second position providing a fluid connection between the inlet and the reservoir, and wherein the second valve has a first position and a second position, the first position providing a fluid connection between the outlet and the external region, and the second position providing a fluid connection between the outlet and the reservoir.

3. The pneumatic circuit of claim 1, further comprising a pressure sensor configured to sense pressure in the reservoir.

4. The pneumatic circuit of claim 1, wherein the pump is configured to pump a gas from the inlet to the outlet.

5. A pneumatic drive apparatus comprising:
a manifold; and
a pneumatic circuit comprising: (i) a pump, (ii) a reservoir, (iii) a first valve operable to selectively provide a fluid connection between an inlet of the pump and the reservoir, (iv) a second valve operable to selectively provide a fluid connection between an outlet of the pump and the reservoir, and (v) a third valve configured to selectively provide a fluid connection between the reservoir and an actuation port, wherein the pneumatic circuit is configured such that the first and second valves are operable to selectively pressurise the reservoir, and such that the third valve is operable to selectively communicate pressure from the reservoir to the actuation port, wherein the manifold comprises a main body in which the reservoir is comprised, wherein the main body is configured to support the first valve, the second valve and the third valve of the pneumatic circuit.

6. The pneumatic drive apparatus of claim 5, wherein the main body is formed of a unitary body.

7. The pneumatic drive apparatus of claim 5, wherein the reservoir comprises a first chamber adjacent the first valve and a second chamber adjacent the second valve, wherein the first chamber and second chamber are connected by a connecting channel.

8. The pneumatic drive apparatus of claim 7, wherein the first chamber and/or the second chamber comprise a bore within the main body of the manifold.

9. The pneumatic drive apparatus of claim 7, wherein respective bores of the first chamber and the second chamber each has a longitudinal axis, the longitudinal axes extending in a longitudinal direction of the manifold.

10. The pneumatic drive apparatus of claim 9, wherein the connecting channel extends between the first chamber and the second chamber in a transverse direction with respect to the longitudinal axes.

11. The pneumatic drive apparatus of claim 7, wherein at least part of the third valve is provided in the connecting channel.

12. The pneumatic drive apparatus of claim 5, wherein the first valve, the second valve, and the third valve are each configured to actuate a corresponding valve plunger in an actuation direction, wherein actuation directions of the first valve, the second valve, and the third valve are coplanar.

13. A pneumatic drive unit comprising:
a housing;
a manifold disposed within the housing; and
a pneumatic circuit comprising: (i) a pump disposed within the housing, (ii) a reservoir, (iii) a first valve operable to selectively provide a fluid connection between an inlet of the pump and the reservoir, (iv) a second valve operable to selectively provide a fluid connection between an outlet of the pump and the reservoir, and (v) a third valve configured to selectively provide a fluid connection between the reservoir and an actuation port, wherein the pneumatic circuit is configured such that the first and second valves are operable to selectively pressurise the reservoir, and such that the third valve is operable to selectively communicate pressure from the reservoir to the actuation port, wherein the manifold comprises a main body in which the reservoir is comprised, wherein the main body is configured to support the first valve, the second valve and the third valve of the pneumatic circuit,
wherein the housing has a width direction transverse to a longitudinal axis of the actuation port, and comprises: a first portion having a first width in the width direction and containing the pump, and a second portion having a second width in the width direction and containing the manifold; wherein the first width is greater than the second width.

14. An assembly comprising:
a plurality of pneumatic drive units, each pneumatic drive unit comprising:
a housing;
a manifold disposed within the housing; and
a pneumatic circuit comprising: (i) a pump disposed within the housing, (ii) a reservoir, (iii) a first valve operable to selectively provide a fluid connection between an inlet of the pump and the reservoir, (iv) a second valve operable to selectively provide a fluid connection between an outlet of the pump and the reservoir, and (v) a third valve configured to selectively provide a fluid connection between the reservoir and an actuation port, wherein the pneumatic circuit is configured such that the first and second valves are operable to selectively pressurise the reservoir, and such that the third valve is operable to selectively communicate pressure from the reservoir to the actuation port, wherein the manifold comprises a main body in which the reservoir is comprised, wherein the main body is configured to support the first valve, the second valve and the third valve of the pneumatic circuit, wherein the housing has a width direction transverse to a longitudinal axis of the actuation port, and comprises: a first portion having a first width in the width direction and containing the pump, and a second portion having a second width in the width direction and containing the manifold; wherein the first width is greater than the second width,
wherein the plurality of pneumatic drive units are arranged such that the actuation ports of the plurality of pneumatic drive units form a linear array distributed along the width direction.

15. The assembly of claim 14, wherein respective pumps of the plurality of pneumatic drive units are distributed along opposing lateral sides of the linear array.
